(19) United States
(12) Patent Application Publication
(10) Pub. No.: US 2014/0188497 A1
(43) Pub. Date: Jul. 3, 2014

(54) INTELLIGENT MESSAGING SYSTEM FOR STATION

(71) Applicant: ADFLOW NETWORKS, INC., Burlington (CA)

(72) Inventors: David M. ROSCOE, Burlington (CA); Tomasz DUCZMAL, Carp (CA)

(73) Assignee: ADFLOW NETWORKS, INC., Burlington (CA)

(21) Appl. No.: 13/835,437

(22) Filed: Mar. 15, 2013

Related U.S. Application Data
(60) Provisional application No. 61/747,625, filed on Dec. 31, 2012.

(51) Int. Cl. G06F 19/00

(52) U.S. Cl. CPC G06F 19/3431
USPC 705/2

(57) ABSTRACT

A method and apparatus is provided for content influencing according to real time and/or dynamic computed profile of a user visiting the apparatus on basis of information obtained about the user by the apparatus at a geographic location.

### CROSS-REFERENCE TO RELATED APPLICATIONS

This application is based upon and claims priority to prior U.S. Provisional Patent Application No. 61/747,625 filed on Dec. 31, 2012 in the US Patent and Trademark Office, the entire contents of which are incorporated herein by reference.

### BACKGROUND

1. Field

Example embodiments relate to information gathering, including biometric, health (medical) related information gathering at a physical station and influencing content responsive to the information gathered.

2. Description of the Related Art

Societies attach great value to providing their aging and disabled populations with adequate care and peace of mind, but changing demographics, economic development, and growing rates of disease and disability have increased the burden on health and social security systems and have endangered the viability of current arrangements. Several medical and technological innovations have theoretically framed this challenge as an opportunity and have caused the health care sector to rethink current paradigms of health care delivery.

During the past decade, there's been significant investment and development in the areas of eHealth or electronic Health (eH), with most of it being centered on early-stage initiatives geared exclusively toward early-adopters, forward-thinking hospitals and tech-savvy physicians. Recently, however, technology and attitudes on both the business management and provider sides have seen a major shift, making eH approachable to a much broader audience.

At present, there are four key areas driving the pace of adoption and the direction of the electronic healthcare industry, including: (1) Innovation in technology; (2) The overall development and adoption of healthcare technology in general; (3) End-user interest and adoption; and (4) The structural/regulatory barriers that already exist in the healthcare industry.

The continued development and adoption of electronic processes and delivery of health information across the entire ecosystem is vital to eH and its future success, both on the consumer side and the physician side. On the consumer side of things, end-user adoption is vital to the future of eH as this is where the benefits will have the greatest impact. Consumer interest is growing in a big way as well, though it mainly lies with early-adopters and the younger demographic. According to a recently released report, 15 percent of 18- to 29 year olds had a health app on their phone compared to 8 percent of 30- to 49-year olds, 6 percent of 50- to 64-year-olds, and 5 percent of people 65-years-old and older. Like most new technologies, younger people drive adoption in the beginning, followed by the older generation as the timeline progresses.

Structural and regulatory barriers that continue to exist in the healthcare industry play a pivotal role in eH. The healthcare industry's tardiness to adopt new technologies and lack of a historically proven return on investment (ROI) to providers will prove to be the most substantial barriers to growth.

As the eH market enters the next phase, it is becoming more and more apparent that the workflows, processes and datasets that are unique to healthcare are essential in order for eH be widely adopted. Internet delivery is not only redefining healthcare, but is streamlining its delivery and consumption within various settings—making it faster, more accurate and cost effective. At present, market in the field of eH has only begun to surface. Things like Short Message Service (SMS)-based appointment reminders and prescription reminders are just now coming into everyday use for some providers. More advanced concepts like remote monitoring and real-time communication between patient and physician are just starting to emerge.

The complexities associated with secure communication have turned many providers away from developing solid solutions. Finding a secure communication that meets compliance regulations and a simple user experience that will enable wide adoption by the end-user would be a significant advance in the art.

Health monitoring is a category with health monitoring covering a wide variety of issues, from glucose monitoring to blood pressure and other traditional health-issue monitoring. The bulk of current eHealth-related monitoring solutions involve clinical-grade solutions, meaning one needs a prescription to take advantage. An early example of eHealth is solutions which monitors and transmits real-time beat-by-beat data to central monitoring locations. It works by leveraging a wireless connection to a landline-connected cradle when in home and a cellular data network when mobile. Another example is the introduction of bio-metric remote monitoring solutions via devices that take the form of arm bands or other devices that are easily wearable for consumers. The barriers that persist include modularization and the standardization of interfaces—such as a standard sensor interface to interact with multiple potential end devices. Overcoming these will be advancement in the art and will drive growth and acceptance across the health industry. In the long-run, web service providers will be required to bring real-time data synching and facilitate centralized analytics.

Electronic kiosks are devices designed for specific uses which include electronic hardware components and housing for the components. The purpose of the kiosk housing is to prevent access or damage to fragile components, and to protect sensitive components from environmental elements, thereby making it feasible for their use in an unsupervised setting. The housing is provided with mountings for the required internal components, fascia for the display devices such as monitors, and apertures for the introduction and removal of credit cards or the issue of printed material. The internal hardware, which may include a monitor, with a pointing device such as a touchscreen or a touch pad and/or keyboard, and a computer (CPU), can perform a variety of functions. If the basic system is expanded by adding a printer, camera, speakers, a microphone, card readers, or other peripherals, and is connected to remote information sources by wire or wireless mechanisms, it can perform a wider variety of tasks including displaying a marketing or health care related messages.

Many medical and health produce retailers offer medical tests and screening for consumers visiting their stores. Most commonly, the retailers check cholesterol levels and blood pressure, although many other tests are available. In addition to supplying a valuable customer service, in-store testing effectively educates consumers about various health problems that can be better managed by a regimen that includes monitoring. Pharmacies and drug retailers have generally found that the availability of screening test devices in the stores increases traffic and cultivates customer loyalty. Automated self-testing blood pressure and heart rate kiosks have been available for many years in many retail stores and pharmacies. These kiosks have proved to be popular with the public to provide health information.

A limitation of the conventional health kiosks is that personalization and customization of the usage experience is limited, so that the conventional health kiosks are essentially information booths with options on the screen without personal service element.

In addition, the health services and information system delivers services in areas ranging from patient education, medical research, and health information. Health care testing is integral to delivery of services since testing and screenings clearly set forth a customer's goals and needs.

To increase attention to the health care screening category, many medical and health produce retailers offer medical tests and screening for consumers visiting their stores. Typically consumers are unaware of the technological advances that have made health care screenings feasible in the clinical, retail, and home settings. Pharmacies and drug retailers have generally found that the availability of test devices in the stores increases traffic and cultivates customer loyalty.

A present concern is that health testing is performed on an insufficient segment of the population to efficiently prevent or treat ailments. Other concerns are that health screening is too costly, limited in scope, and time-consuming both for individual patients and health care providers. Despite these deficiencies, a strong awareness exists of a need and desire for improved health screening procedures and equipment. Health care providers, insurance companies, and employers that ultimately pay for health care have encouraged development and usage of improved, accurate yet economic health testing facilities both for treatment and prevention of health care problems.

Manufacturers and retailers expend a significant amount of resources distributing promotions in an attempt to entice consumers to purchase a particular health care product. Due to the variety of consumers in the marketplace today, it is inevitable that different consumers will be enticed in different ways by a promotion. For example, some consumers may be persuaded to purchase a product based on creative advertising for the product, while others are enticed solely by the dollar amount of a purchase incentive for the product.

Therefore, there is a need to draw people to stations, for example, kiosks, including health kiosks.

### SUMMARY

Example embodiments relate to information of a user (person) obtained, including biometric, health (medical) related information gathered at a physical station and influencing content for the user responsive to the information gathered.

Example embodiments relate to medical information gathering, namely data pertaining to or based upon evidence of the state of a person's health, and generation of health related information, including marketing, entertainment, educational, motivational, fitness related information.

A method and apparatus is provided for content influencing according to real time and/or dynamic computed profile of a user visiting the apparatus on basis of information obtained about the user by the apparatus at a geographic location.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram of a system, according to an embodiment of the present invention;

FIG. 2 is a diagram of a health station, according to an embodiment of the present invention;

FIG. 3 is functional block diagram of a server computer, according to an embodiment of the present invention;

FIG. 4 is functional block diagram of a computer, which is a machine, for implementing embodiments of the present invention.

### DETAILED DESCRIPTION OF EMBODIMENTS

Reference will now be made in detail to embodiments, examples of which are illustrated in the accompanying drawings, wherein like reference numerals refer to like elements throughout. Embodiments are described below to explain the present disclosure by referring to the figures.

Example embodiments relate to information of a user (person) obtained, including biometric, health (medical) related information gathering at a physical station and influencing content for the user responsive to the information gathered. According to an aspect of an embodiment, content influenced by information obtained at a physical station, such as a kiosk, is presented to the user in form of a message, advertisement, or coupon. The influenced content can be provided for the user by way of one or more delivery media, for example, displayed at the station, output at the station (printed), electronic mail, text (short message service (SMS) to a mobile device, at a point of sale (POS) for the user, or social network online service.

Example embodiments relate to information gathering, including medical information, namely data pertaining ID or based upon evidence of the state of a person's health, biometric data, namely the measuring and analysis of physical attributes of a person such as facial features, voice, retinal scans, or deoxyribonucleic acid (DNA) used to predict, infer, allude to or define a person's characteristics, unique identity, for influencing content delivery, for example, generation of health related information, including marketing (e.g., advertisements, coupons), entertainment, educational, motivational, fitness related information. Evidence of the state of a person's health can be acquired by one or more physiological, including biometric, sensors to measure physiological, including biometric, data of, for example, a person.

Currently known promotional strategies distribute targeted promotions to customers based on the product purchase history of the customer. In contrast, according to the embodiments, the effectiveness of such promotional programs is further determined by obtaining information of a person at a physical station at a location where people frequent, for example, at the mall or a retail store, and influencing content provided to the person based upon the obtained information. To draw a person to the physical station, the station can perform medical or health related information gathering, for example, testing, measuring, as well as provide entertainment and games, for example, photographing, access to social network online services, thereby providing a benefit of regularly drawing or attracting persons to the physical station. Typically, the information gathering at the station is anonymous to protect the users privacy and anonymous user profile categories are generated on basis of information gathered at a station.

According to an aspect of an embodiment, a user can authorize more personally influenced content for delivery by authorizing access to user's personal profile via authentication and subsequent access to personally influenced content, for example, content may be influenced according time, location of station and user profile category.

According to an aspect of an embodiment, the physical station, for example, kiosk, supports building anonymous user profiles to influence content to be delivered to a user.

For example, while currently known promotional strategies distribute targeted promotions to customers based on the product purchase history of the customer, according to the embodiments the effectiveness of such promotional programs is further determined by linking health care screening and testing with entertainment and games available at a station, thereby providing a benefit of regularly drawing or attracting persons to a health kiosk. In addition, it is known that manufacturers and retailers distribute promotions for their products through a variety of distribution mediums such as the postal service, newspapers or magazines, printing from a point of sale terminal at a checkout counter in a grocery store, and, most recently, the Internet. However, customers are primarily exposed to promotional efforts through a small number of mediums accessible and/or preferable to the individual customer, and current promotional programs attempt to deliver promotions to individual customers without regard to the medium preferable to the customer. These promotional programs could also lead to ineffective and wasted promotional efforts. With the increase of commerce over the Internet, consumers are being bombarded with advertisements and mailings that include blanket promotions that do not dynamically take into account the consumer's personal needs and interests, for example, with regard to a user profile (e.g., anonymous, personal), time and geographic location. Accordingly an aspect of an embodiment, ‘user profile’ denotes anonymous and/or personal user profile as the case maybe.

According to an embodiment, a consumer is selectively targeted for content that is influenced by instant or current anonymous information of a user obtained at a station and historical anonymous information of prior users obtained at the station by engaging the consumers into activities at the station, including an important activity of health monitoring to receive content influenced by anonymous information of the user or intent/desire to receive content influenced by anonymous information of the user, for example, biometric measurement, for example, facial recognition to categorize a user profile based upon predicted mood, age, gender, cultural interest. According to an aspect of an embodiment, as a part of larger system the individual health test can become an element of sharing information with others over social networks if intended by users and the act of sharing health information itself concurrently builds a more accurate anonymous profile as an indicator of strength of the station users' interest in health which enhances the targeted promotion. The loop is closed and customer gets a better service with marketer being more efficient.

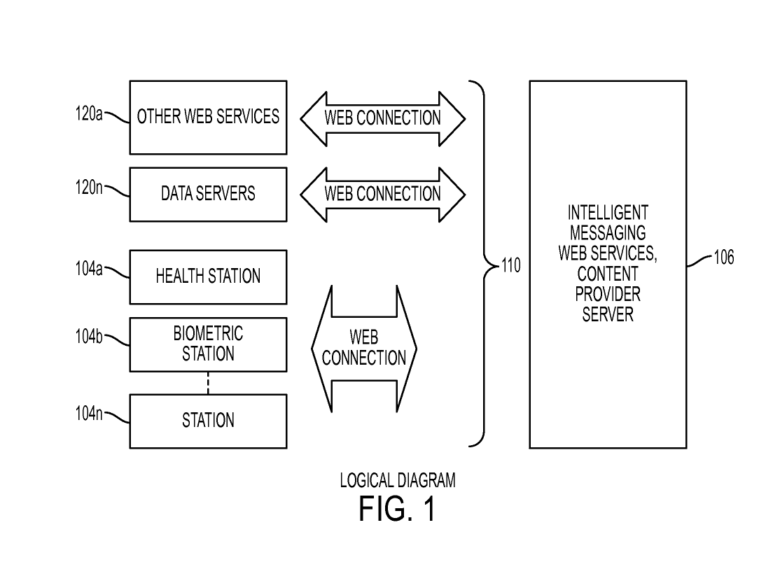

Referring to FIG. 1 a plurality of stations (also referred to as kiosk) 104ₐ₋ₙ are connected to a computer server 106 (the Intelligent Messaging Service server) via a data communication network, for example the Internet, World Wide Web 110. The server 106 in turn can access other web services 120ₐ₋ₙ to augment its own functionality, for example, accessing categorized user profiles (e.g., anonymous and/or personal user profiles) based upon the information obtained at the station 104, for storage, image processing, health testing/monitoring, etc. In other words, according to an aspect of an embodiment, a physical station 104 at a physical geographic location includes one or more hardware processors to execute obtaining information of a user on basis of interaction with the station, processing the obtained information (e.g., processing of the obtained information can be performed at the station or by transmission to a data server 120 or to an intelligent messaging web server 106) for categorization of the obtained information into an anonymous user profile, and providing content for the user influenced by the categorized anonymous user profile.

According to an aspect of an embodiment, a data server 120 implementing a decision engine categorizes information obtained at the stations 104 into categorized user profiles and associates a segmentation ID (identifier, value) 307 to the categorized user profiles. An intelligent messaging web services 106 of a content provider, for example, an advertiser, is utilizable on basis of the segmentation IDs to influence content to be provided to a user. According to an aspect of an embodiment, a decision engine can be implemented as part of a data server 120 that receives user related information from stations 104 for generating categorized user profiles under control of entity managing the stations 104 independent of content providers for preserving user privacy, security of information, and which data server 120 utilizes the intelligent messaging web services 106 of third party content providers to influence pulled content and/or the decision engine can be implemented as part of the intelligent messaging web services 106 of content providers. According to another aspect of an embodiment, a content provider pulls segmentation IDs from the data server 120 and provides content influenced by the segmentation ID to a user. According to another aspect of an embodiment a content provider provides content responsive to analysis of segmentation IDs associated with categorized user profiles. According to an aspect of an embodiment, segmentation IDs may be based upon a group of user profiles. According to an aspect of an embodiment, information obtained at the station 104 triggers generations of a segmentation ID corresponding to a category of user profile, the generated segmentation ID triggering output of content influenced by the user profile. Analysis of information of a user obtained at a station for categorization into a user profile can be based upon one or more of a type of hardware processor collecting information of the user, a sponsor of or organizer for the station, geographic location of the station, event information by the location, age, gender, occupation, education, cultural interest, test result based upon physiological data including biometric data, facial features based upon facial recognition, user mood based upon biometric measurements, voice based upon biometric measurements, weather, time, user status in an online service (e.g., social network online service) or game (e.g., status of a user in an online service or game to influence content), and an inviting mechanism of the station. According to an aspect of an embodiment from a combination of the categories a user profile is inferred.

Using a health monitoring (medical) station as an example, according to an aspect of an embodiment a system and method for distributing marketing campaigns on a network of digital signs placed in a health monitoring station (HMS). An HMS includes mechanisms, for example, biometric measurement devices, for identification of a living thing, such as a person (user), animal, plant, for allowing unobtrusive registration and recognition of the living thing to categorize information obtained into anonymous and/or personal user profiles; physiological measurements devices including, for example in case of a user, a blood pressure recorder, heart rate recorder, and/or weight recorder. Input/output devices communicate with the appropriate web services for data storage and driving logic.

The interaction interface of the health monitoring station (HMS) includes one or more of a screen, camera, microphone, speakers, and/or printer. The whole HMS assembly enables a user to have the ability to perform health tests which enable the display of marketing and/or education messages during and/or after the test. An HMS can also include a face recognition as biometric measurement device 230 to obtain identifying information for generating a user profile (e.g., anonymous, personal).

According to an aspect of an embodiment, the health monitoring stations (HMS) are networked over the Internet, and communicate with a central web service server that manages the logic and data flow of the user health test sessions. The pluralities of such similar stations are managed by the server which maintains the user's profile, connection history by the HMS and/or by the user to the server and messaging history to/from the HMS. The user profile is based on the results of physiological test, data gathered during test sessions, face recognition, history of usage and several results created from statistical models calculated on the server. The server builds a tailored message according to user profile and makes the message available for the HMS to display, for example during the health test.

A benefit of an embodiment is that personalized test and personalized incentives during the user session builds customer loyalty and generates repeated visits. Individual customer incentives for the HMS are distributed via printed coupons or by SMS to a radio device (e.g., mobile phone). The central server has ability to communicate health tests of the user and send them to social networks, healthcare and/or commercial networks sites if desired and configured.

Referring to FIG. 1 a plurality of the health stations (also referred to as kiosk) 104ₐ₋ₙ are connected to a computer server 106 (the Intelligent Messaging Service server) via a data communication network, for example the Internet, World Wide Web 110. The server 106 in turn can access other web services 120ₐ₋ₙ to augment its own functionality, for example for storage, image processing, health testing/monitoring, etc.

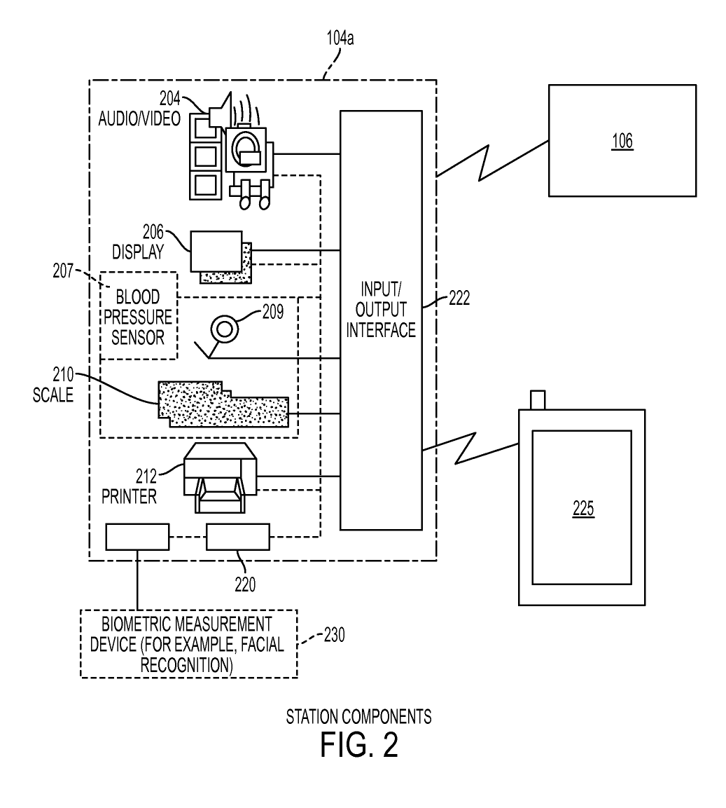

Referring to FIG. 2, a station 104a is an assembly of input-output devices enabling interaction between user and other systems. According to example embodiments, a station 104, for example, in form of a kiosk 104, may include components, such as one or more audio/video/image devices 204, including a display, a speaker, a microphone; one or more physiological, including biometric, hardware processors, for example, sensors 207, such as a blood pressure sensor/meter 208, a weight scale 210; other input/output device(s), including a keyboard, touch screen display 206, printer 212; and a processing device 220 that is configured to control the components and to output of information at the kiosk 104 and/or to the server 106, via input/output interfaces 222, relating to/concerning a physiological measurement, input and/or by one or more sensors, of a user. In FIG. 2, a kiosk 104 can also include a biometric measurement device 230 as a hardware processor, for example, a facial recognizer. Available physiological sensors, including biometric measurement devices can be used.

A kiosk 104 may be a fixture, a computer implemented media player, an enclosed structure (e.g., an enclosed apparatus, a booth with open sides or windows, a room) and/or an open structure (e.g., a place, a station, a table), with interactive (direct and/or indirect) user access to the physiological sensors and/or biometric measurement devices. A kiosk 104 may be an electronic or computer kiosk with physiological sensors 207. According to an aspect of an embodiment, the kiosk 104 can input/output information using a data network transceiver over wire and/or wirelessly (e.g., a phone network, local WiFi) to a remote terminal 225, such as a mobile phone or mobile device. According to an aspect of an embodiment, a station 104 may be a device (machine) capable of physiological measurements and/or biometric measurements.

For example, the station 104 is an enclosure, allowing a user to enter the station and feel isolated from the surroundings. The entry to the station displays basic information about type of medical test and/or entertainment is offered inside the station. An inviting mechanism is provided to draw a person to conduct a medical test, the inviting mechanisms can have different forms like a flat display screen displaying medical test and/or marketing information or holographic image projecting a real person. The inviting mechanism to the station can be in form of accommodating interaction with external online services, for example, social network online services (input of status, update to status, photo upload, etc.), including games thereon, and/or games or services of interest at the station, for example, software supporting a health challenge competition, wellness program, or an interface to corporate health challenge competition, wellness program, video games at the station or accessible online games, and/or a photo booth service. Invitation to use station is an important feature which pre-screens a potential user to a customer with genuine interest in the topic represented by the combination of the test devices of the station 104. If station 104 is equipped with scale 210 and blood pressure sensor 208, it can be determined to appeal to a person with a heart problem. If the station 104 is equipped with glucometer, the station 104 will appeal to people concerned with diabetes. The fact that a user chooses a particular station is a very strong indicator of the profile of the user and immediately narrows the class of effective marketing, such as advertisements, and/or entertainment, for such user. Therefore, one or more different types of user services provided at the station as inviting mechanisms to a station are utilizable to influence content.

In addition, the station may be equipped with a biometric measurement device 230, for example, a facial recognition device, to recognize a face of a user for user profile analysis (for establishing a category of a user profile) to influence content to be provided to the user and/or based upon a pattern or statistical model of facial recognitions at the station to influence content for the user as well as other users at or near the geographical location of the station. According, to an aspect of an embodiment, the statistical model takes into account a time period, such as time during a day, month, or year and/or an information about an event (sale campaign, entertainment event, such as music concert or theater, political, electronic educational services, occupational services, at the location of the station.

According to an aspect of an embodiment, the station 104 is a content influencing device according to real time and/or dynamic computed profile, including updated profile, of a user(s) (anonymous and/or personal crowd profile) visiting the station on basis of information as influencing factors obtained about the user by the station. Content can be dynamically influenced for a location of the station according to detecting a user profile trend based upon the computed profiles of a plurality of user depending upon a threshold visiting the station. Visitation to the station 104 can be by way of near field communication (NFC) techniques with a mobile device of a user to obtain user profile information, for example, as a user passes by the station. A content provider can dynamically determine to purchase a marketing space depending upon or triggered by a user profile trend detected by the station, and provide content influenced by the user profile trend to users of the content provider (on a personalized basis based upon prior relationship of a user with the content provider) and/or anonymous users. According to an aspect of an embodiment, user or crowd profiling by the content influencing device is on basis of prior obtained permission from users by/from an organizer or sponsor of the content influencing device for purpose of delivering influenced content, such as promotional material, health related messages, coupons on basis of information collected by the station. A sponsor of a station can be content or service or product provider entity.

For the purpose of illustration and clarity, the description which follows focuses on the heart health case with a health station 104a including a weight scale 210 and a blood pressure sensor 208. Referring to FIG. 2 the interior of the station 104 includes a scale 210 mounted into the floor of the station 104, a blood pressure measurements cuff 208, and a display 206 with video and audio devices 204. When a customer enters the station 104, a medical test session for the customer starts with greetings. For example, the station system is initialized, weight of the customer is recorded and an image of the face of customer is transmitted to the server 106.

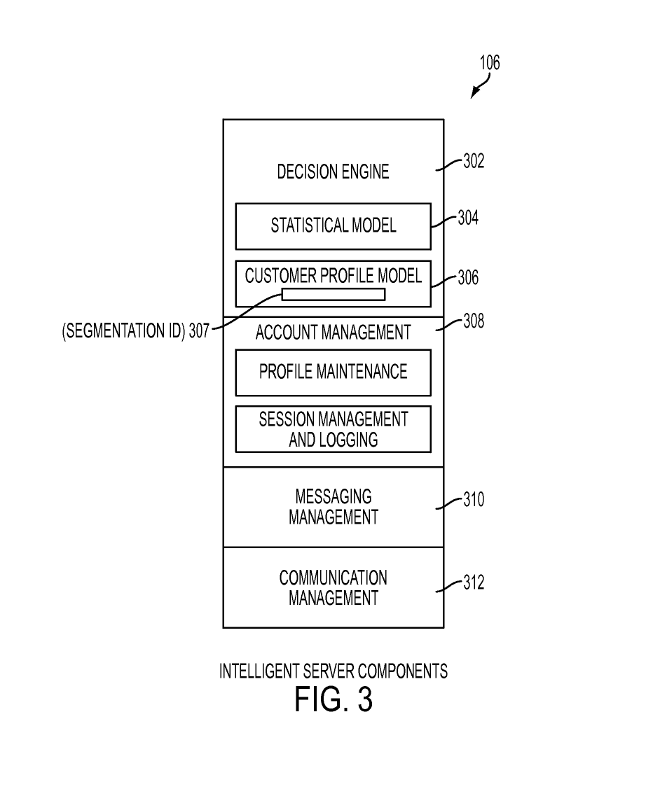

FIG. 3 is a functional block diagram of a server computer, according to an embodiment of the present invention. According to an aspect of an embodiment, a server computer 106 is configured (e.g., programmed) to generate a statistical model 304, a customer profile model 306, and to execute a decision engine 302, account management 308, messaging management 310 and communication management 312.

Referring to FIG. 3 the Intelligent Messaging Server 106 hosts following logical blocks:

1. Communication Management 312. The module is responsible for all tasks associated with supporting and maintaining a secure communication with health station nodes 104. A unique feature of the security is a pulling method of acquiring user profiles, play lists and IDs.

2. Messaging Management 310. The module is responsible for all tasks associated with supporting and maintaining a media, play lists and campaign management including access by marketers.

3. Account Management 308. The module is responsible for all tasks associated with supporting and maintaining user's personal profiles and connection session including exchanging tests history and play lists history.

4. Decision Engine 302. This module contain main logic for managing health station nodes 104 and plays a coordination role in triggering tasks and redirecting data flow according to different scenarios required for station nodes 104. Integral parts of the Decision Engine module are statistical models 304 generating scores (for example, weight) and segmentation IDs to be used in the logic which matching play lists to the user profiles 306.

Case 1 New Customer:

In case of personal user profiles, if an image of a customer is not matched to entries in a database, the initiation session is triggered. New account is created, weight of the user is recorded and several questions are posed to the user. User is presented with option to make blood pressure measurement. Once all medical data related to the user are gathered and acquired, the decision engine 302 generates a user profile based upon the acquired medical data and a matching class of advertisement ID (segmentation ID) is sent to station 104a.

According to an aspect of an embodiment, a segmentation ID is based upon the information obtained about the user at the station and the type of information obtained (e.g., physiological test, facial recognition) and the type of device (a hardware processor 207, 230) used to obtain the information (e.g., a physiological sensor, biometric measurement device), or any combinations thereof. Advertisements may be generated and/or stored in a database based upon a combination of type of medical data acquired, a state of physiological measurement (e.g., increase, decrease in comparison relation to prior measurement data) and a profile (e.g., a user's profile). A user profile can be user related information, including user's state or status (current or historical or pattern) in social networks (social network software applications). Social network attributes of a user can be retrieved by interfacing with social network site databases storing a user's social network information. A pattern can be generated accordingly as a health message. Profiles can be organized in classes according to, for example, social network, personal information (e.g., age, personal address, geographical location, occupation, name, income, marital status, gender) etc. The pre-assembled play list (for example, health related message) for a given profile class is played on the station's display 206. The IDs of the media are stored together with the generated user profile. The station 104a pulls media for a play list during idle time. During session only test data and profile category ID are exchanged between station 104a and server 106.

Case 2 Returning Customer:

In case of personal user profiles, if an image of the customer matches previous entries, a repeated visit session is triggered. The profile of the user is retrieved and the history of medial related measurements is transferred to the station 104a. The new measurements are taken and the user's profile is updated. The decision engine 302 recalculates the user's profile. A new play list ID is sent to the station 104a and matching media are played. The incentives (coupon or SMS) are distributed. According to an aspect of an embodiment, the user's profile or profile model 306 is updated according to both a most recent physiological data of the user and a geographic location of the health station 104. In addition, the statistical model 304 for the user is generated based upon a pattern of the user's physiological data acquired at a health station 104 over various set (user settable, system settable) periods of time. The statistical model 304 could determine a pattern based upon a plurality of different geographically located health stations 104.

According to an aspect of an embodiment, the statistical model can be based upon a combination of a physiological measurement for a user, user's profile, including user's social network status or attributes to build a broader health profile utilizable for further health advice, or diagnosis, or prognosis; user health profile, predictions (influence), monitoring. The functions and operations described herein can be performed dynamically and/or in real time to provide health related message services. According to an aspect of an embodiment, a trigger for a heath related message can be in response to an action/activity at a health station (e.g., acquired physiological data) and/or from change in social network status or attribute (e.g., to prompt, notify, or encourage, or remind of an action/activity at a health station).

According to aspect of an embodiment, physiological measurements are treated equally with other web services (e.g., social network sites, gaming sites) to put together an entertainment package derived from physiological data. According to an aspect of an embodiment, a most recent physiological data is compared with a history of physiological data and a threshold, and rewards or points are issued accordingly, or physiological data, including profile, social network attribute, based patterns are graphically displayed.

A method and apparatus (e.g., a station 104) is provided for content influencing according to real time and/or dynamic computed profile of a user visiting the apparatus on basis of information obtained about the user by the apparatus at a geographic location. A physical station locatable at a physical geographic location, comprises one or more hardware processors to execute obtaining information of a user on basis of user interaction with the station; processing the information obtained for categorizing the information into an anonymous user profile; and triggering output of content influenced by categorization of the anonymous user profile. A hardware processor is configured to acquire physiological data related to the user during a user session at the physical station and the content is influenced according to the physiological data. A hardware processor is a transceiver to communicate over a network with a content provider server; and one or more categorizations of anonymous user profiles is assigned a segmentation ID according to analysis of the information obtained for the anonymous user profiles and the segmentation ID 307 triggers output of influenced content of the content provider server. According to an aspect of an embodiment, a composite segmentation ID of a plurality of segmentation IDSs (grouping, for example, based upon processing of assigned weights or average of weights of collected information for categorization into user profile) triggers output of influenced content. According to an aspect of an embodiment, a segmentation ID made available to external systems or sources external to the station and utilized in (specified in) XML, HTML documents that represent an advertisement, or promotional or influenced content campaign, data structure to trigger upon reading (processing) by a machine, output of content influenced according to categorization of user profile.

A method and system of presenting a health related message to a user, comprising: configuring a plurality of geographically distributed medical information gathering stations that include and/or interface with one or more physiological sensors to: acquire physiological data related to the user during a user session at a geographic location, and transmit the physiological data of the user to a server apparatus; and configuring the server apparatus to: update a profile of the user based on the acquired physiological data of the user; obtaining a health message according to the physiological based updated user profile, and transmit the health message.

According to an embodiment, the health message is based upon both a most recent physiological data of the user and a geographic location of the medical information gathering device.

A messaging system targeting pre-screened users to improve message impact and tailor message to user profile.

A system for performing health test as a part of entertaining session to improve message impact and user experience.

A method of secure delivery of a tailored message driven by the user profile.

A method of unobtrusive user recognition (e.g., user's image) to associate person with stored profile and session history.

A method of building customer loyalty by communicating test results to social networking sites chosen by the user.

A method of building customer loyalty by providing health tests presented as a game;

A method of generating a user profile based on data acquired during system usage to customize a marketing message.

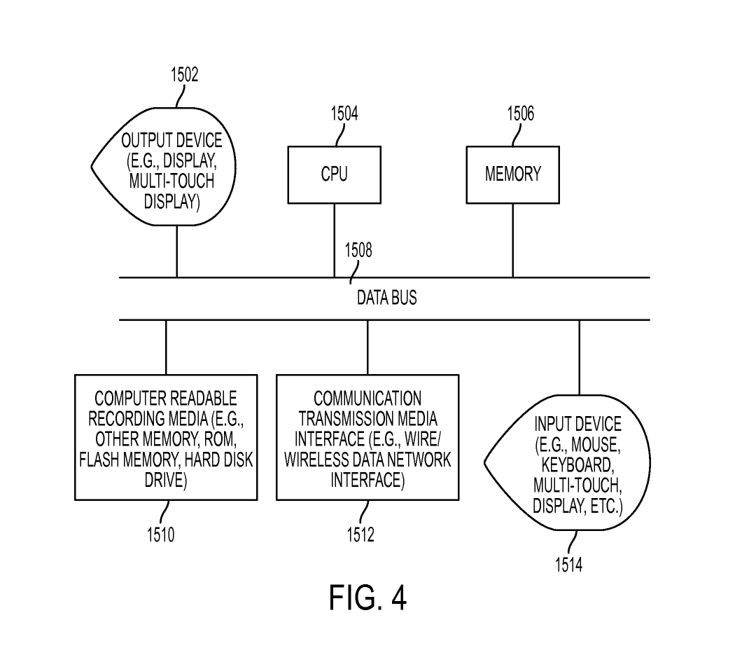

FIG. 4 is a functional block diagram of a processing device, such as a computer (hardware computing/processing machine) for the embodiments of the invention, namely a computer configured to execute functions of the station 104 and server 106. In FIG. 4, the computer can be any computing device that can execute instructions to provide the described functions. Typically, the computer includes an input device 1514 (for example, a mouse, keyboard, multi-touch display screen, etc.), output device 1502 (for example, a display to display a user interface or output information, printer, etc). One or more computer controller(s) or processing cores 1504 (e.g., a hardware central processing unit) executes instructions (e.g., a computer program or software) that control the apparatus to perform operations. According to an aspect of an embodiment, one or more networked computer servers, each with a number of processing cores, execute the described operations.

Typically, a memory component 1506 stores the instructions for execution by the controller 1504. According to an aspect of an embodiment, the apparatus reads/writes/processes data of any computer readable recording or storage media 1510 and/or communication transmission media interface 1512. The communication transmission media interface is to data network with one or other machines (e.g., computers, a distributed network) to execute the described functions. The embodiments can be implemented via grid computing. The display 1502, the CPU 1504 (e.g., hardware logic circuitry based computer processor that processes instructions, namely software), the memory 1506, the computer readable media 1510, and the communication transmission media interface 1512 are in communication by one or more the data bus(es) 1508.

According to an aspect of the embodiments of the invention, any combinations of one or more of the described features, functions, operations, and/or benefits can be provided. A combination can be one or a plurality. The term ‘a’ refers to one or more. The embodiments can be implemented as an apparatus (a machine) that includes hardware for performing the described features, functions, operations, and/or benefits, for example, hardware, including hardware processors, to perform functions, to measure, to transmit/receive data, that function as an instrument, as an optical lens, execute instructions or software, for example, computing hardware (i.e., computing apparatus), such as (in a non-limiting example) any computer or computer processor that can store, receive, retrieve, process and/or output data and/or communicate (network) with other computers. According to an aspect of an embodiment, the described features, functions, operations, and/or benefits can be implemented by and/or use computing hardware and/or software. For example, the health station 104, which is a machine, communicably connects to a server device 106, which is a machine, and each can comprise a computing controller (CPU) (e.g., a hardware logic circuitry based computer processor that processes or executes instructions, namely software/program), computer readable media, transmission communication interface (network interface), input device, and/or an output device, for example, a display device, and which can be in communication among each other through one or more data communication buses. In addition, an apparatus can include one or more apparatuses in computer network communication with each other or other devices. In addition, a computer processor can refer to one or more computer processors in one or more apparatuses or any combinations of one or more computer processors and/or apparatuses. An aspect of an embodiment relates to causing and/or configuring one or more apparatuses and/or computer processors to execute the described operations. The results produced can be output to an output device, for example, displayed on the display. An apparatus or device refers to a physical machine that performs operations, for example, a computer (physical computing hardware or machinery) that implement or execute instructions, for example, by way of software, which is code executed by computing hardware, and/or by way of computing hardware (e.g., in circuitry, etc.), to achieve the functions or operations being described. The functions of embodiments described can be implemented in any type of apparatus that can execute instructions or code. More particularly, programming or configuring or causing an apparatus or device, for example, a computer, to execute the described functions of embodiments of the invention creates a new machine where in case of a computer a general purpose computer in effect becomes a special purpose computer once it is programmed or configured or caused to perform particular functions of the embodiments of the invention pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc - Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A physical station locatable at a physical geographic location, comprising:
one or more hardware processors to execute:
obtaining information of a user on basis of user interaction with the station;
processing the information obtained for categorizing the information into an anonymous user profile; and
triggering output of content influenced by categorization of the anonymous user profile.

2. The physical station according to claim 1, wherein a hardware processor is configured to acquire physiological data related to the user during a user session at the physical station and the content is influenced according to the physiological data.

3. The physical station according to claim 1, wherein a hardware processor is a transceiver to communicate over a network with a content provider server; and
one or more categorizations of anonymous user profiles is assigned a segmentation ID according to analysis of the information obtained for the anonymous user profiles and the segmentation ID triggers output of influenced content of the content provider server.

4. The physical station according to claim 2, wherein the anonymous user profile is computed based upon a statistical model including a type of hardware processor collecting the physiological data including biometric data of the user, information on geographic location of the physical station and one or more of age, gender and a test result based upon the physiological data.

5. The physical station according to claim 1, wherein the anonymous user profile is computed based upon a type of hardware processor collecting physiological data including biometric data of the user, and other different type of user service provided at the station.

6. The physical station according to claim 5, wherein the biometric data is facial recognition.

7. The physical station according to claim 2, the content is influenced according to a pattern of physiological data of users acquired for the station over a period of time.

8. The physical station according to claim 2, wherein the content is further influenced according to a geographic location of the station.

9. The physical station according to claim 5, wherein the other different type of user service provided at the station is a health challenge competition online service on basis of the collected physiological data including biometric data of users by the station.

10. A method, comprising:
locating a physical station at a physical geographic location; and
executing by one or more hardware processors of the physical station:
obtaining information of a user on basis of user interaction with the station;
processing the information obtained for categorizing the information into an anonymous user profile; and
triggering output of content influenced by categorization of the anonymous user profile.

11. The method according to claim 10, wherein the executing further comprises acquiring physiological data related to the user during a user session at the physical station, wherein the content is influenced according to the physiological data.

12. The method according to claim 10, wherein the executing further comprises:
assigning a segmentation ID to one or more categorizations of anonymous user profiles according to analysis of the information obtained for the anonymous user profiles, wherein the segmentation ID triggers output of influenced content of the content provider server.

13. The method according to claim 11, wherein the anonymous user profile is computed based upon a statistical model including a type of hardware processor collecting the physiological data including biometric data of the user, information on geographic location of the physical station and one or more of age, gender and a test result based upon the physiological data.
